(19) United States
(12) Patent Application Publication
(10) Pub. No.: US 2021/0068026 A1
(43) Pub. Date: Mar. 4, 2021

(54) WIRELESS COMMUNICATION METHOD AND AERIAL USER EQUIPMENT

(71) Applicant: NTT DOCOMO, INC., Tokyo (JP)

(72) Inventors: Jing Wang, Beijing (CN); Hanning Wang, Beijing (CN); Liu Liu, Beijing (CN)

(73) Assignee: NTT DOCOMO, INC., Tokyo (JP)

(21) Appl. No.: 16/964,872

(22) PCT Filed: Jan. 24, 2019
(86) PCT No.: PCT/CN2019/072984

§ 371 Date: Jul. 24, 2020

(30) Foreign Application Priority Data
Jan. 26, 2018 (CN) 201810078835.7

(51) Int. Cl. H04W 36/30; H04W 36/00; H04W 36/08; H04W 24/10; H04B 7/185

(52) U.S. Cl. CPC H04W 36/30; H04W 36/0083; H04B 7/18502; H04W 36/0061; H04W 24/10; H04W 36/08

(57) ABSTRACT

Provided are a wireless communication method and a base station. The method is applied to a current serving base station of an aerial user equipment and includes: selecting a part of candidate base stations from multiple candidate base stations as candidate serving base stations of the aerial user equipment; transmitting, to the aerial user equipment, a measurement instruction for the candidate serving base stations; and selecting a next serving base station of the aerial user equipment from the candidate serving base stations according to measurement results.

### TECHNICAL FIELD

The present application relates to a field of wireless communications, and in particular, to a wireless communication method applied to an aerial user equipment.

### BACKGROUND

In recent years, drones, aerials or unmanned aerial vehicles (UAVs) have been widely used, and wireless communication networks such as Long Term Evolution (LTE) networks may be used to support drone services, for example, communicate with drones during drones' flights, or supporting ground controllers/personnel to communicate with drones over wireless networks, due to their good coverage performance. Here, a user equipment such as a drone that is capable of flying in the air and capable of communicating with a base station through a wireless communication network may be referred to as an aerial user equipment.

In a wireless communication system, there are many base stations. In existing cell planning methods, each base station may serve as a serving base station of the aerial user equipment, and the aerial user equipment may be handed over between the respective base stations. Compared to a terrestrial user equipment, the aerial user equipment tends to move faster, so it may be handed over between the respective base stations more frequently. In addition, since the aerial user equipment is flying in the air, and there are fewer obstacles between the aerial user equipment and the base stations, the aerial user equipment may have a communication condition of a line-of-sight transmission, so a reference signal receiving power of the aerial user equipment is higher than that of the terrestrial user equipment. At the same time, base stations in a farther and wider range may detect the aerial user equipment such that these base stations suffer interference from the aerial user equipment, and the aerial user equipment also suffers interference from these base stations. The more densely the base stations are deployed, the more serious the mutual interference between the aerial user equipment and the base stations are. In addition, the intensity and range of interference experienced by the aerial user equipment at different heights are also greatly different.

Therefore, for the aerial user equipment, a new cell planning method is needed to solve the above problems.

### SUMMARY OF THE INVENTION

According to one aspect of the present disclosure, a wireless communication method applied to a current serving base station of an aerial user equipment is provided, including: selecting a part of candidate base stations from multiple candidate base stations as candidate serving base stations of the aerial user equipment; transmitting, to the aerial user equipment, a measurement instruction for the candidate serving base stations; and selecting a next serving base station of the aerial user equipment from the candidate serving base stations according to a measurement result.

According to one aspect of the present disclosure, a base station is provided, including: a selecting unit, configured to select a part of candidate base stations from multiple candidate base stations as candidate serving base stations of an aerial user equipment; a transmitting unit, configured to transmit a measurement instruction for the candidate serving base stations to the aerial user equipment; and a selecting unit, configured to select a next serving base station of the aerial user equipment from the candidate serving base stations according to a measurement result.

According to one aspect of the present disclosure, a wireless communication method applied to an aerial user equipment is provided, including: receiving a measurement instruction for candidate serving base stations transmitted by a serving base station, the candidate serving base stations being a part of candidate base stations selected from multiple candidate base stations; performing measurement the part of candidate base stations according to the measurement instruction; and transmitting a measurement result to the serving base station.

According to one aspect of the present disclosure, an aerial user equipment is provided, including: a receiving unit configured to receive a measurement instruction for candidate serving base stations transmitted by a serving base station, the candidate serving base stations being a part of candidate base stations selected from multiple candidate base stations; a measuring unit configured to perform measurement on the candidate serving base stations according to the measurement instruction; a transmitting unit configured to transmit a measurement result to the serving base station.

In the above aspects of the present disclosure, among multiple base stations existing in the wireless communication system, only a part of the base stations may be candidate serving base stations of the aerial user equipment, that is, base stations capable of serving the aerial user equipment, thereby reducing interference between the aerial user equipment and the respective base stations and achieving better communication performance between the aerial user equipment and the wireless communication network.

### BRIEF DESCRIPTION OF THE DRAWINGS

The above and other objects, features and advantages of the present disclosure will become more apparent by describing embodiments of the present disclosure in more details with reference to accompanying drawings. The accompanying drawings are intended to provide a further understanding of the embodiments of the present disclosure, and constitute a part of the specification, to explain the present disclosure together with embodiments of the present disclosure, and do not constitute a limitation on the present disclosure. Throughout the accompanying drawings, like reference numerals generally represent like components or steps.

FIG. 1 shows a schematic diagram of a wireless communication system for implementing embodiments of the present disclosure;

FIG. 2 shows a flow diagram of a method of wireless communication performed by a current serving base station of an aerial user equipment according to one embodiment of the present disclosure;

FIGS. 3(a)-3(c) show examples of selecting different proportions of candidate serving base stations for aerial user equipment in different heights according to embodiments of the present disclosure;

FIG. 4 shows an example of selecting same proportion of candidate serving base stations for aerial user equipment at different heights according to embodiments of the present disclosure;

FIG. 5 shows a schematic diagram of a base station performing an intra-frequency ANR function in an LTE system;

FIG. 6 shows a schematic diagram of a base station performing an inter-frequency ANR function in an LTE system;

FIG. 7 shows an example of performing a next serving base station handover procedure by a current serving base station according to embodiments of the present disclosure;

FIGS. 8(a)-8(b) show an example in which one or more base stations other than the serving base station and the candidate serving base stations of an aerial user equipment are muted based on different muting patterns according to embodiments of the present disclosure;

FIGS. 9(a)-9(b) show another example in which one or more base stations other than the serving base station and the candidate serving base stations of an aerial user equipment are muted based on different muting patterns according to embodiments of the present disclosure;

FIG. 10 shows a flow diagram of a method of wireless communication performed by an aerial user equipment according to one embodiment of the present disclosure;

FIG. 11 shows a schematic diagram of a structure of a base station according to one embodiment of the present disclosure;

FIG. 12 shows a schematic diagram of a structure of a user equipment according to one embodiment of the present disclosure; and

FIG. 13 shows a schematic diagram of a hardware structure of a user equipment and a base station according to one embodiment of the present disclosure.

### DESCRIPTION OF THE EMBODIMENTS

In order to make objects, technical solutions and advantages of the present disclosure more apparent, exemplary embodiments according to the present disclosure will be described in detail below with reference to the accompanying drawings.

First, a wireless communication system in which embodiments of the present disclosure may be applied will be described with reference to FIG. 1. The wireless communication system may be an LTE wireless communication system or any other type of wireless communication system. In the following, the embodiments of the present disclosure are described by taking an LTE network as an example, but it should be appreciated that the following description is also applicable to other types of wireless communication networks.

As shown in FIG. 1, the wireless communication system includes multiple base stations (BSs) and a user equipment (UE) 20. The multiple base stations include base stations 10, 30, 40, 50, and the like. The user equipment 20 may communicate with the base station 10, in other words, the base station 10 is the current serving base station of the user equipment 20. The user equipment 20 may be an aerial vehicle (AV) capable of flying in the air and capable of communicating with the base station 10, for example a drone or a UAV (for example, a drone or a UAV based on a 3GPP specification Rel. 15). Here, a user equipment or user terminal capable of flying in the air and capable of carrying out wireless communication with the base station is referred to as an aerial user equipment, which may also be interchangeably referred to as a flight user terminal, an aerial user equipment, an aerial user terminal, or the like. It should be appreciated that although multiple base stations and one aerial user equipment are shown in FIG. 1, this is merely illustrative, and the wireless communication system may include more/fewer base stations and/or multiple aerial user equipment. In addition, the wireless communication system may also include one or more user equipment or terminals (not shown) that are not aerial user equipment, that is, terrestrial user equipment or terminals. In addition, in the following, cells and base stations are sometimes used interchangeably.

As described above, in existing wireless communication systems, all base stations may serve as candidate serving base stations of the aerial user equipment to serve the aerial user equipment, and these base stations are too dense for the aerial user equipment. The inventors have recognized that in all base stations of the wireless communication system, only a part of the base stations need to be selected as the candidate serving base stations of the aerial user equipment. Accordingly, when a handover is required, the aerial user equipment may be handed over between only the respective candidate serving base stations, instead of being handed over between all base stations. Thereby, it is possible to avoid the problem of a drop in the quality of communication during movement caused by the excessive number of candidate serving base stations.

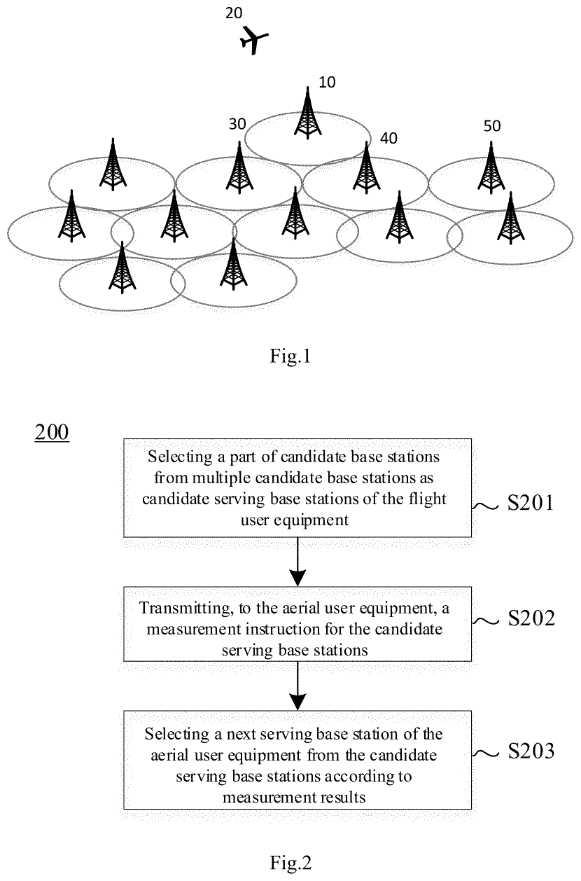

A method of the wireless communication according to the embodiments of the present disclosure will be described below with reference to FIG. 2. The method may be performed by the base station 10. As described above, the base station 10 is the current serving base station of the aerial user equipment 20. FIG. 2 shows a flow chart of the method of the wireless communication. By this method, the current serving base station 10 may select a next serving base station of the aerial user equipment 20 so that the aerial user equipment is handed over to the next serving base station.

As shown in FIG. 2, in step S201, the serving base station 10 may select a part of candidate base stations from multiple candidate base stations as the candidate serving base stations of the aerial user equipment.

The multiple candidate base stations may be a part or all of base stations existing in the area where the aerial user equipment is located in the wireless communication system. Alternatively, the multiple candidate base stations may be a part or all of base stations in neighbor relationships maintained by the serving base station 10, for example, a part or all of base stations in a neighbor cell list (NCL) maintained by the serving base station 10, or a part or all of base stations in a neighbor relation table (NRT) maintained by the serving base station 10. The NRT will be described later.

In this embodiment, the part of the candidate base stations may be selected from the multiple candidate base stations as the candidate serving base stations of the aerial user equipment according to a height of the aerial user equipment.

First, the number of the part of the candidate base stations, that is, the number of the candidate base stations to act as the candidate serving base stations of the aerial user equipment, may be determined according to the height of the aerial user equipment.

In a first implementation, the number of the selected part of the candidate base stations may be different for the aerial user equipment at different heights.

In one example, when the height of the aerial user equipment is less than a predetermined height, since the number of obstacles between the aerial user equipment and the base station increases, the aerial user equipment in the height range may not have a communication condition of the line-of-sight transmission, and the aerial user equipment may face a same transmission environment as the terrestrial user equipment. Therefore, more base stations may be selected for the aerial user equipment in this height range to ensure good communication of the aerial user equipment. For example, all or a first proportion of the multiple candidate base stations may be selected as the candidate serving base stations of the aerial user equipment, and the first proportion may be, for example, a relatively high proportion such as 90%. Here, the predetermined height may be flexibly determined according to the specific conditions of the wireless communication system, for example, the predetermined height may be 50 meters.

In addition, when the height of the aerial user equipment is greater than the predetermined height, the number of the part of the candidate base stations increases as the height of the aerial user equipment increases. Specifically, when the height of the aerial user equipment is greater than the predetermined height, the number of obstacles between the aerial user equipment and the base station decreases, therefore only a smaller number of base stations are required to ensure the good communication of the aerial user equipment. Therefore, a smaller number of base stations may be selected from all base stations as the candidate serving base stations of the aerial user equipment, compared with the case where the height of the aerial user equipment is less than the predetermined height. In addition, as the height of the aerial user equipment increases, the communication quality deteriorates because a communication distance between the aerial user equipment and the base station becomes larger, therefore more base stations may be selected to ensure the good communication of the aerial user equipment, compared with the aerial user equipment at the predetermined height. For example, one or more height ranges may be set from the predetermined height, and for each height range, a corresponding candidate serving base station selection proportion is set, so that when the height of the aerial user equipment is within a certain height range, the corresponding proportion of the candidate serving base stations are selected. For example, three height ranges of 50-100 meters, 100-200 meters, and 200-300 meters may be set, and the corresponding proportions for the candidate serving base stations may be set to 20%, 30%, and 50%, respectively. It should be noted that the number of the height ranges and the corresponding proportions are only examples, and may be flexibly selected according to actual situations.

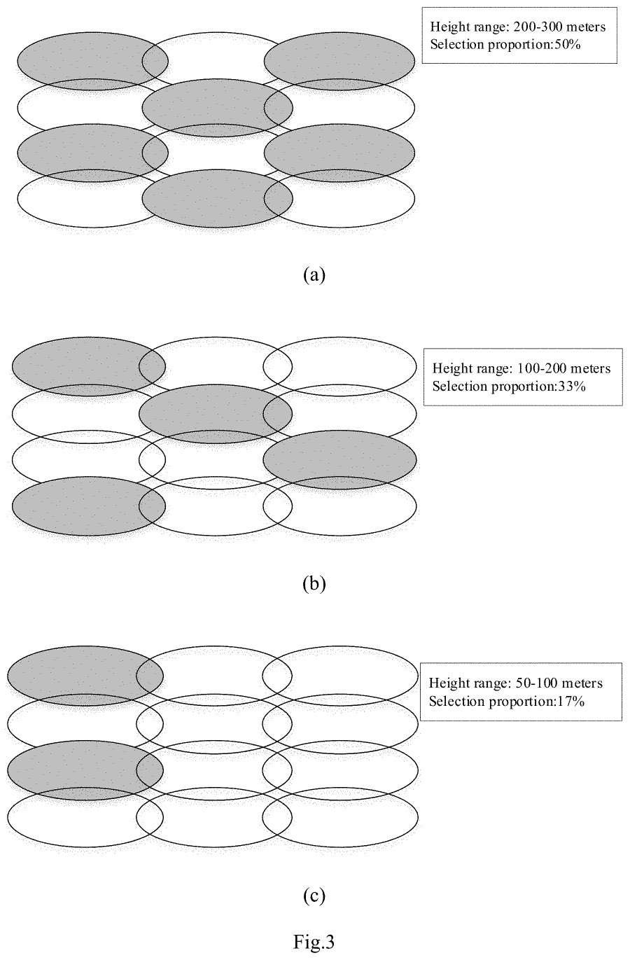

FIG. 3 shows examples of selecting the candidate serving base stations of different proportions for the aerial user equipment at different heights according to the embodiments of the present disclosure. As shown in FIG. 3(a), for an aerial user equipment within a height range of 200-300 meters, the candidate serving base stations of 50% (indicated by gray circles) may be selected; as shown in FIG. 3(b), for an aerial user equipment within a height range of 100-200 meters, the candidate serving base stations of 33% may be selected; as shown in FIG. 3(c), for an aerial user equipment within a height range of 50-100 meters, the candidate serving base stations of 17% may be selected.

In a second implementation, the number of the part of the candidate base stations may be the same for the aerial user equipment at different heights.

For example, for the aerial user equipment at different heights, a predetermined proportion of base stations may be selected from the multiple candidate base stations as the candidate serving base stations of the aerial user equipment regardless of the height factor. The predetermined proportion may be flexibly determined according to actual situations of the wireless communication system. For example, the predetermined proportion may be set to 50%, and in this case, for the aerial user equipment at different heights, 50% of the multiple candidate base stations may be selected as the candidate serving base stations of the aerial user equipment.

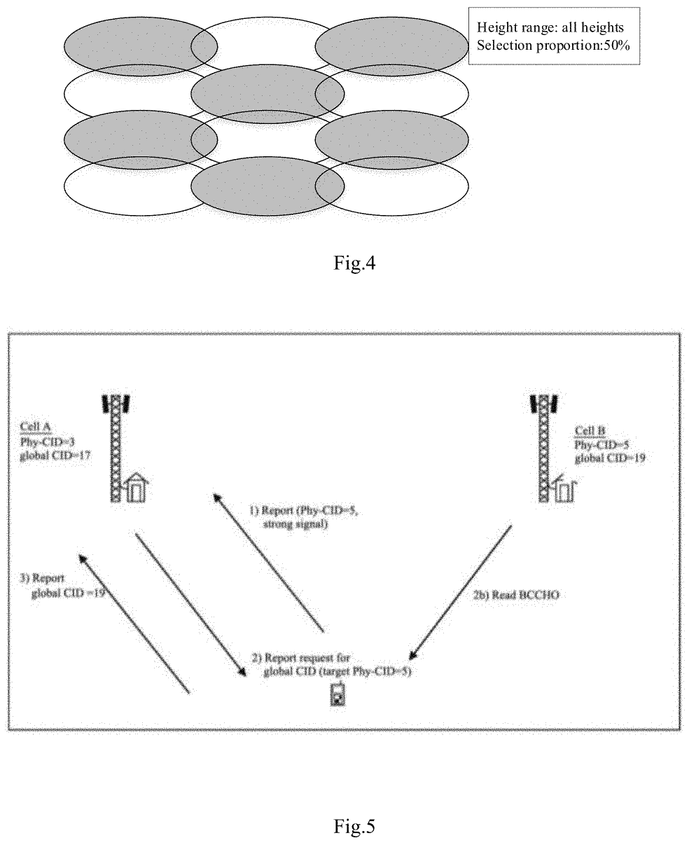

FIG. 4 shows an example of selecting the candidate serving base stations of the same proportion for the aerial user equipment at different heights according to the embodiments of the present disclosure. As shown in FIG. 4, the candidate serving base stations of 50% (indicated by gray circles) are selected for the aerial user equipment at different heights or height ranges.

After determining the number of the candidate serving base stations to be selected, the candidate serving base stations may be specifically determined from the multiple candidate base stations in various manners.

In a first implementation, the part of the candidate base stations may be uniformly or substantially uniformly selected from the multiple candidate base stations as the candidate serving base stations of the aerial user equipment.

As one example, after determining the number of the candidate serving base stations, the serving base station 10 may select the part of the candidate base stations of this number uniformly or substantially uniformly according to specific geographic locations of the multiple candidate base stations. That is, the serving base station 10 may select the number of candidate serving base stations such that a distribution of geographic locations of the selected candidate serving base stations is uniform or substantially uniform. It should be noted that the method for the uniform selection is not limited thereto, and any method consistent with the uniform selection is applicable to the present disclosure. FIG. 4 corresponds to the case of uniform selection.

In a second implementation, the serving base station 10 may select the part of the candidate base stations from the multiple candidate base stations, as the candidate serving base stations of the aerial user equipment, according to workloads of the respective candidate base stations. As one example, the part of the candidate base stations with a load lower than a threshold may be selected from the multiple candidate base stations as the candidate serving base stations of the aerial user equipment. The threshold may be predetermined and may be flexibly determined by the serving base station 10 according to the actual situations. For example, the threshold may be a threshold specified in a 3GPP standard. Alternatively, one or more candidate base stations with the lowest load may be selected from the multiple candidate base stations as the candidate serving base stations of the aerial user equipment.

As described above, the multiple candidate base stations may be a part or all of the base stations existing in the area where the aerial user equipment is located in the wireless communication system. In this case, a list of all the base stations may be configured by an operator and provided to the serving base station 10, such that the serving base station 10 may make the selection.

Alternatively, the multiple candidate base stations may be base stations included in one of multiple NRTs maintained by the serving base station 10.

Specifically, in an LTE system, the base station (for example, the serving base station 10) may detect neighbor cells by an Automatic Neighbor Relationship (ANR) function, and maintain (establish and/or update) multiple NRTs according to the type of the user equipment. Specifically, the base station creates an NRT and records related information of its own neighbor cells therein, adds related information of a new neighbor cell to the NRT when the new neighbor cell is found, and deletes a neighbor cell from the NRT when the neighbor cell is out of date. Table 1 below shows an example of NRT.

TABLE 1

| NR | TCI | No Remove | No HO | No X2 |
|---|---|---|---|---|
| 1 | TCI#1 | | | |
| 2 | TCI#2 | ✓ | | ✓ |
| 3 | TCI#3 | ✓ | | |

Each Neighbor Relation (NR) entry in Table 1 records related information of one neighbor cell. In each entry, the TCI is a target cell identifier of a neighbor cell (that is, a target cell). For the LTE network, the TCI may correspond to an E-UTRAN Cell Global Identifier (ECGI) and a Physical Cell Identifier (PCI) of the neighbor cell. Each NR entry may also have three attributes, where “No Remove” indicates whether the base station will remove the NR from the NRT, and for example when selected (“√”), it indicates that the NR is not removed; “HO” indicates whether the base station will use the NR for handover, and for example, when selected (“√”), the NR is not used for handover; “No X2” indicates whether the NR will use an X2 interface to initiate an related process for a base station managing a corresponding cell, and for example, when selected (“√”), the NR will not use the X2 interface to initiate the process.

The ANR function may include an intra-frequency ANR function and an inter-frequency ANR function. FIG. 5 schematically shows a process in which the base station performs the intra-frequency ANR function in the LTE system. The base station that manages a cell A shown in FIG. 5 may correspond to the base station 10 shown in FIG. 1. As shown in FIG. 5, in step 1), a user equipment in the cell A measures a signal reception quality of a neighbor cell, and transmits a measurement report about the neighbor cell to the base station. In this example, assume that the neighbor cell is a cell B, and the measurement report contains indication information PCI (for example, 5) of the cell B, but does not contain a global CID (for example, EGCI) of the cell B. In step 2), the base station transmits a request to report the global CID (for example, EGCI) of the newly found cell B to the user equipment with the PCI of the cell B as a parameter. In response to the request, in step 2b), the user equipment acquires the global CID (for example, 19) of the cell B by receiving a broadcast channel transmitted by the cell B, and reports the global CID of the cell B to the base station in step 3). Then, the base station may add an entry corresponding to the cell B into the NRT. In this way, the base station maintains the NRT.

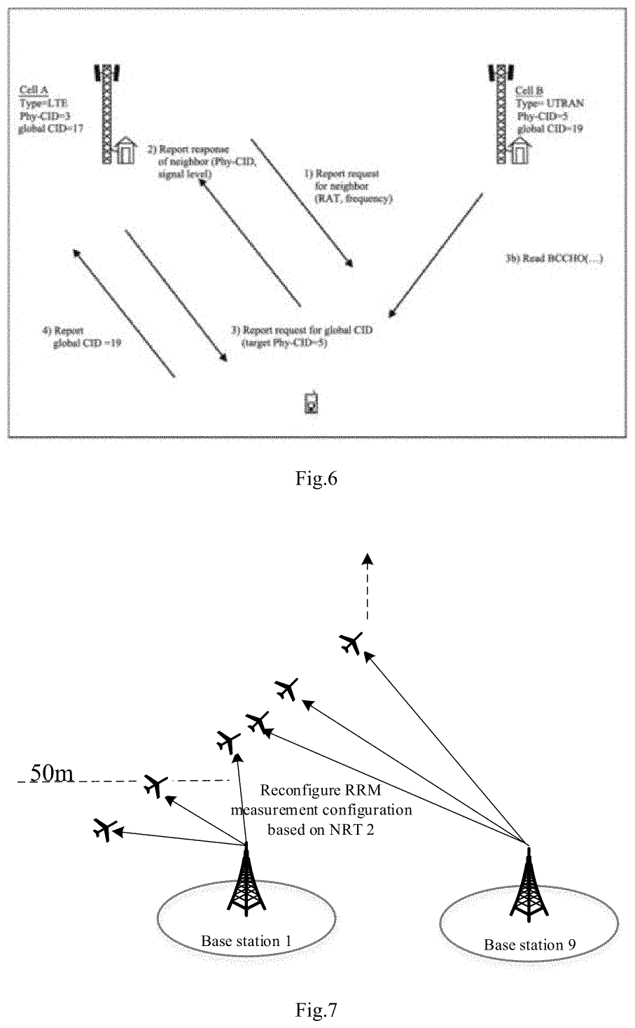

FIG. 6 schematically shows a process in which the base station performs the inter-frequency ANR function in the LTE system. The base station that manages a cell A shown in FIG. 6 may correspond to the base station 10 shown in FIG. 1. As shown in FIG. 6, in step 1), the base station (LTE base station) that manages the cell A transmits a request to the user equipment to measure a neighbor cell of other frequency or RAT. In step 2), in response to the request, the user equipment measures a signal reception quality of a neighbor cell, and transmits a measurement report about the neighbor cell to the base station. In this example, assume that the neighbor cell is a cell B (UTRAN base station), then the measurement report contains a PCI (for example, 5) of the cell B, but does not contain a global CID (EGCI) of the cell B. In step 3), the base station transmits a request to report the global CID (for example, EGCI) of the newly found cell B to the user equipment with the PCI of the cell B as a parameter. In response to the request, in step 3b), the user equipment acquires the global CID (for example, 19) of the cell B by receiving a broadcast channel transmitted by the cell B, and reports the global CID of the cell B to the base station in step 4). Then, the base station may add an entry corresponding to the cell B into the NRT. In this way, the base station maintains the NRT.

In a first implementation, the serving base station 10 may maintain multiple neighbor relationship tables, and the multiple neighbor relationship tables correspond to different heights of user equipment respectively. In this case, the multiple candidate base stations are selected from one of the multiple neighbor relationship tables which corresponds to the height of the aerial user equipment.

In this implementation, because the number of obstacles between the aerial user equipment at a lower height and the base station increases, the aerial user equipment at the lower height may not have the communication condition of the line-of-sight transmission, and the aerial user equipment at the lower height may face a same transmission environment as a terrestrial user equipment. Therefore, when maintaining the NRT, the base station may not distinguish between the aerial user equipment and the terrestrial user equipment, but only maintain (establish and/or update) different NRTs according to the heights of the user equipment.

As one example, in the case of maintaining the multiple NRTs, the serving base station 10 may divide the found neighboring base stations into one or more groups according to the heights, where each group corresponds to one height or height range, and the group of neighboring base stations corresponding to the height are included in the NRT corresponding to the height. For example, for a height range of H1-H2 (for example, 0-50 meters), a dedicated NRT is maintained, for a height range H2-H3 (for example, 50-100 meters), another dedicated NRT is maintained, and so on, thereby multiple NRTs are maintained. Each NRT may be used for user equipment at a corresponding height. In this case, each NRT may be as shown in Table 1 above.

In a second implementation, one NRT may be maintained, that is, the found neighboring base stations are included in the one NRT. In addition, these neighboring base stations are divided into one or more groups, with each group corresponding to one height or height range. In the NRT, a new attribute may be added to a NR entry corresponding to each neighbor cell. For example, a “Height” attribute is added to the NR entry to indicate a height range corresponding to the base station. Table 2 below shows an example of the NRT.

TABLE 2

| NR | TCI | No Remove | No HO | No X2 | Height | |
|---|---|---|---|---|---|---|
| 1 | TCI#1 | | | | 0-50 | m |
| 2 | TCI#2 | ✓ | | ✓ | 100-200 | m |
| 3 | TCI#3 | ✓ | | | 50-100 | m |

In a third implementation, the serving base station 10 may maintain multiple neighbor relationship tables, and the multiple neighbor relationship tables correspond to different types of user equipment respectively. In this case, the multiple candidate serving base stations are selected from one of the multiple neighbor relationship tables which corresponds to the type of the aerial user equipment.

As one example, in the case of maintaining the multiple NRTs, the serving base station 10 may divide the found neighboring base stations into multiple groups according to the types of supported user equipment, where each group corresponds to one type of user equipment, and the group of neighboring base stations corresponding to the type is included in the NRT corresponding to the type. Specifically, as described above, aerial user equipment and terrestrial user equipment may exist in a mobile communication system. Thus, the supported user equipment types may include terrestrial user equipment and aerial user equipment. In this case, for example, a dedicated NRT is maintained for the terrestrial user equipment and another dedicated NRT is maintained for the aerial user equipment.

In a fourth implementation, one NRT may be maintained, that is, the found neighboring base stations are included in the one NRT. In addition, these neighboring base stations are divided into one or more groups, each group corresponding to one type of user equipment. In the NRT, a new attribute may be added to a NR entry corresponding to each neighbor cell. For example, a type of the user equipment corresponding to the “Aerial-serving” attribute may be added into the NR entry, and for example, when selected (“√”), it indicates that the NR may serve the aerial user equipment. Table 3 below shows an example of NRT.

TABLE 3

| NR | TCI | No Remove | No HO | No X2 | Aerial-serving |
|---|---|---|---|---|---|
| 1 | TCI#1 | | | | ✓ |
| 2 | TCI#2 | ✓ | | ✓ | |
| 3 | TCI#3 | ✓ | | | ✓ |

In a fifth implementation, the serving base station 10 may maintain multiple neighbor relationship tables, and the multiple neighbor relationship tables correspond to different heights and types of user equipment respectively. In this case, the multiple candidate base stations are selected from one of the multiple neighbor relationship tables which corresponds to the height and type of the aerial user equipment.

As one example, in the case where the multiple NRTs are maintained (established and/or updated) by the ANR function, the serving base station 10 may divide the found neighboring base stations into multiple groups according to the heights or height ranges and the types, where each group correspond to a combination of one type and one height or height range, and the group of neighboring base stations corresponding to the height or height range and the type of user equipment are included in the NRT corresponding to the height or height range and the type.

For example, one dedicated NRT is maintained (established and/or updated) for terrestrial user equipment within the height range of H1-H2 (for example, 0-50 meters), one dedicated NRT is maintained (established and/or updated) for aerial user equipment within the height range of H1-H2 (for example, 50-100 meters), another dedicated NRT is maintained (established and/or updated) for aerial user equipment within the height range of H2-H3 (for example, 100-200 meters), and so on, thereby multiple NRTs are maintained.

In a sixth implementation, a shared NRT may be maintained, and in the NRT, a new attribute may be added to an NR entry corresponding to a neighbor cell reported by the user equipment. For example, a “Height” attribute and an “Aerial-serving” attribute may be added to the NR entry. The “Height” indicates a height or height range of the user equipment supported by the neighbor cell. The “Aerial-serving” indicates whether the neighbor cell corresponding to the entry supports an aerial user equipment, and for example when selected (“√”), it indicates that the NR may serve the aerial user equipment. Then, each row of the NR entry corresponds to whether one neighbor cell supports the aerial user equipment and the height range of the supported aerial user equipment. Table 4 below shows an example of the NRT.

TABLE 4

| | | | | | | |
|---|---|---|---|---|---|---|
| | | | | | | Aerial- |
| NR | TCI | No Remove | No HO | No X2 | Height | serving |

| | | | | | | |
|---|---|---|---|---|---|---|
| 1 | TCI#1 | | | 0-50 | m | |
| 2 | TCI#2 | ✓ | ✓ | 100-200 | m | ✓ |
| 3 | TCI#3 | ✓ | | 50-100 | m | ✓ |

In step S202, the serving base station 10 transmits a measurement instruction for the candidate serving base stations to the aerial user equipment.

The measurement instruction may be RRM measurement configuration and/or mobility configuration that instructs the aerial user equipment to measure channel qualities of the candidate serving base stations. It should be appreciated that in addition to the RRM measurement configuration and/or mobility configuration described above, the measurement instruction may be other form of instruction that instructs the aerial user equipment to perform channel quality measurements on the candidate serving base stations. After measuring the channel qualities of the candidate serving base stations, the aerial user equipment feeds back the measurement results to the base station.

In step S203, the serving base station 10 selects a next serving base station of the aerial user equipment from the candidate serving base stations according to the measurement results.

The serving base station 10 receives the transmitted measurement results (that is, the channel qualities of the respective candidate serving base stations) from the aerial user equipment. The base station then selects one base station from the candidate serving base stations according to the received measurement results of the respective candidate serving base stations, as the next serving base station of the aerial user equipment. For example, the serving base station may select one base station with the best channel quality from the respective candidate serving base stations, as the serving base station of the aerial user equipment.

After selecting the next serving base station, the base station may transmit a handover request to this serving base station so that the aerial user equipment is handed over to this base station.

Through the above method, only a part of the base stations in the wireless communication system may be used as the candidate serving base stations of the aerial user equipment, thereby avoiding the problem that the communication quality during movement is degraded due to excessive candidate serving base stations.

It should be noted that the serving base station 10 may perform the above method at an appropriate timing. For example, in the case of maintaining NRTs respectively corresponding to different heights, it is assumed that the serving base station 10 is a serving base station selected from an NRT corresponding to a first height. When the height of the aerial user equipment changes to a second height, the serving base station determines whether it is in an NRT corresponding to the second height. If the serving base station is in the NRT corresponding to the second height, the serving base station 10 continues to serve the aerial user equipment. Alternatively, if the serving base station is in the NRT corresponding to the second height, the serving base station 10 may reconfigure the RRM measurement configuration for the aerial user equipment and transmit it to the aerial user equipment, so as to select a new serving base station according to the measurement results of the user equipment. On the other hand, if the serving base station is not in the NRT corresponding to the second height, the serving base station performs the method described above with reference to FIG. 2, reconfiguring the RRM measurement configuration for the aerial user equipment, selecting the next serving base station of the aerial user equipment, and causing the aerial user equipment to hand over to the next serving base station.

FIG. 7 shows an example of performing a process of handover to the next serving base station performed by the current serving base station.

As shown in FIG. 7, when the height of the aerial user equipment is below 50 meters, it corresponds to an NRT 1 of the current serving base station (base station 1 in this example). In this case, the serving base station of the aerial user equipment is selected from NRT 1. When the height of the aerial user equipment is above 50 meters, it corresponds to a NRT 2. In this case, the current serving base station of the aerial user equipment will select the NRT 2 corresponding to the current height of the aerial user equipment, reconfigure the RRM measurement configuration based on the NRT 2 and transmit it to the aerial user equipment, and then selects the new serving base station (base station 9 in this example) based on the measurement results of the aerial user equipment.

In addition, when the serving base station serves the aerial user equipment, interference of remaining base stations (one or more base stations other than the serving base station and the candidate serving base stations) to the aerial user equipment may be reduced by inter-cell interference coordination (ICIC). As one implementation, in the case that the serving base station serves the aerial user equipment, one or more base stations other than the serving base station and the candidate serving base stations may be muted, so that the one or more base stations other than the serving base station and the candidate serving base stations do not send signals when the serving base station is serving the aerial user equipment, so as to reduce the interference of the one or more base stations other than the serving base station and the candidate serving base stations to the aerial user equipment, thereby achieving better communication performance between the aerial user equipment and the wireless communication network.

Specifically, when the serving base station serves the aerial user equipment, a notification may be transmitted to the one or more base stations other than the serving base station and the candidate serving base stations by X2 signaling, so that the one or more base stations other than the serving base station and the candidate serving base stations are muted. The notification may include an indication to perform muting and resource information for performing muting, for example, a subframe, a frequency resource block, or the like. For example, the notification may be transmitted by reusing signaling in an existing coordinated multipoint (CoMP). The notification information may be transmitted by the serving base station of the aerial user equipment or may be transmitted by a central controller controlling all base stations. After receiving the notification information for muting, the base station that needs to be muted is muted according to the notification information. Next, when the serving base station stops serving the aerial user equipment, the muting of the one or more base stations other than the serving base station and the candidate serving base stations may be released by notification information. As described above, the notification information may be transmitted by the serving base station of the aerial user equipment or may be transmitted by the central controller that controls all base stations. The one or more base stations to be muted may be selected from the remaining base stations in different muting patterns.

In one implementation, one or more base stations other than the serving base station and the candidate serving base stations are muted in the same or different muting patterns for the aerial user equipment at different heights. That is, when the aerial user equipment is at different heights, one or more same base stations other than the serving base station and the candidate serving base stations are muted, or one or more different base stations other than the serving base station and the candidate serving base stations are muted. In another implementation, one or more base stations other than the serving base station and the candidate serving base stations are muted in the same or different muting patterns according to the number of base stations serving different aerial user equipments. For example, when there are a first number of base stations in the wireless system serving the aerial user equipment, a first group (one or more) of base stations other than the serving base station and the candidate serving base stations are muted, and when there are a second number of base stations in the wireless system serving the aerial user equipment, a second group (one or more) of base stations other than the serving base station and the candidate serving base stations are muted, where at least one different base station may exist between the first group of base stations and the second group of base stations.

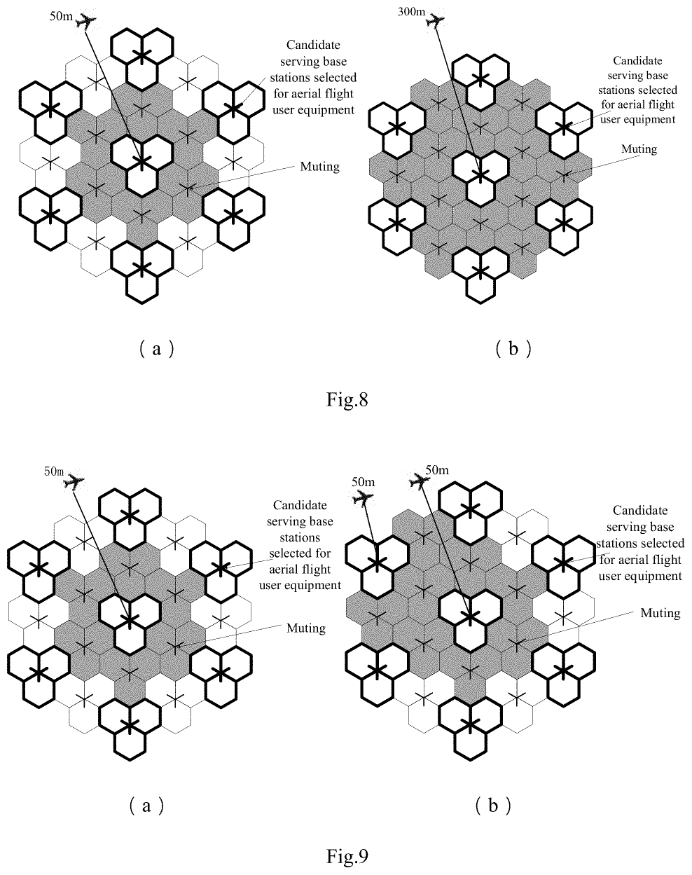

FIG. 8 shows an example in which one or more base stations other than the serving base station and the candidate serving base stations of the aerial user equipment are muted in different muting patterns according to the embodiments of the present disclosure. As shown in FIGS. 8(a)-8(b), every three cells are controlled by one base station, where base stations corresponding to cells with bold black borders are the candidate serving base stations selected for the aerial user equipment, a gray area represents muted base stations, and multiple base stations other than the serving base station and the candidate serving base station are muted in different muting patterns. As shown in FIG. 8(a), the height of the aerial user equipment is 50 meters. As shown in FIG. 8(b), the height of the aerial user equipment is 300 meters. Multiple base stations other than the serving base station and the candidate serving base stations shown in FIG. 8(a) are muted in a first muting pattern, and multiple base stations other than the serving base station and the candidate serving base stations shown in FIG. 8(b) are muted in a second muting pattern different from the first muting pattern.

FIG. 9 shows another example in which one or more base stations other than the serving base station and the candidate serving base stations of the aerial user equipment are muted in different muting patterns according to the embodiments of the present disclosure. As shown in FIGS. 9(a)-9(b), every three cells are controlled by one base station, and base stations corresponding to cells with bold black borders are the candidate serving base stations selected for the aerial user equipment, a gray area represents the muted base stations, and multiple base stations other than the serving base station and the candidate serving base station are muted in different muting patterns for different numbers of base stations serving different aerial user equipments. As shown in FIG. 9 (a), one base station serves the aerial user equipment. As shown in FIG. 9 (b), two base stations serve two aerial user equipments respectively. Multiple base stations other than the serving base station and the candidate serving base stations shown in FIG. 9(a) are muted in a first muting pattern, and multiple base stations other than the serving base station and the candidate serving base stations shown in FIG. 9(b) are muted in a second muting pattern different from the first muting pattern.

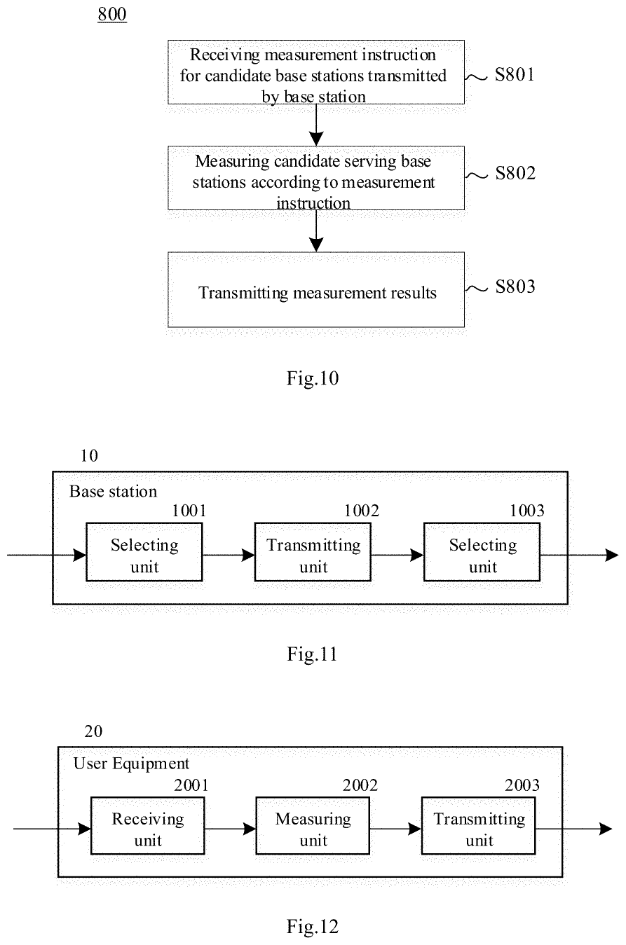

Hereinafter, a wireless communication method performed by an aerial user equipment according to one embodiment of the present disclosure will be described with reference to FIG. 10. This method corresponds to the method described with reference to FIG. 2, and since many details have been described above according to FIG. 2, a description of the same details is omitted herein to avoid repetition.

As shown in FIG. 10, in step S801, a measurement instruction for candidate serving base stations, which is transmitted by a serving base station, is received, and the candidate serving base stations is a part of candidate base stations selected from multiple candidate base stations. The measurement instruction for the candidate serving base stations may be received in a manner known in the art, and a method of selecting the candidate serving base stations from the multiple candidate base stations is the same as the above method, details omitted herein.

Next, in step S802, the aerial user equipment may perform measurement on the candidate serving base stations according to the measurement instruction.

The measurement instruction may be RRM measurement configuration and/or mobility configuration that instructs the aerial user equipment to measure the channel quality of the candidate serving base stations. It should be appreciated that in addition to the RRM measurement configuration and/or mobility configuration described above, the measurement instruction may be other forms of instruction that instructs the aerial user equipment to perform channel quality measurement on the candidate serving base stations.

In step S803, measurement results are transmitted to the serving base station.

After measuring the channel qualities of the candidate serving base stations, the aerial user equipment feeds back the measurement results to the base station. The base station selects a next serving base station of the aerial user equipment from the candidate serving base stations according to the measurement results, and then the aerial user equipment is handed over to the next serving base station.

Next, a base station according to one embodiment of the present disclosure will be described with reference to FIG. 11. FIG. 11 shows a schematic diagram of a structure of a base station according to one embodiment of the present disclosure. Since functions of the base station of the present embodiment are the same as those of the method described above with reference to FIG. 2, detailed descriptions of the same content are omitted herein for the sake of simplicity.

As shown in FIG. 11, the serving base station 10 includes a selecting unit 1001, a transmitting unit 1002, and a selecting unit 1003. It should be noted that although the base station is shown in FIG. 11 to include only three units, this is merely illustrative, and the base station may also include one or more other units, which are not related to the inventive concept and are omitted here.

The selecting unit 1001 may select a part of candidate base stations from multiple candidate base stations as candidate serving base stations of an aerial user equipment.

The multiple candidate base stations may be a part or all of base stations existing in an area where the aerial user equipment is located in the wireless communication system. Alternatively, the multiple candidate base stations may be a part or all of base stations in neighbor relationship maintained by the serving base station 10, for example, a part or all of base stations in a NCL maintained by the serving base station 10, or a part or all of base stations in a NRT maintained by the serving base station 10. The NRT will be described later.

In this embodiment, the selecting unit 1001 may select the part of the candidate base stations from the multiple candidate base stations according to a height of the aerial user equipment, as candidate serving base stations of the aerial user equipment.

First, the selecting unit 1001 may determine a number of the part of the candidate base stations, that is, a number of the candidate serving base stations to act as the candidate serving base stations of the aerial user equipment, according to the height of the aerial user equipment.

In a first implementation, the number of the selected part of the candidate base stations may be different for the aerial user equipment at different heights.

In one example, when the height of the aerial user equipment is less than a predetermined height, the aerial user equipment in the height range may not have a communication condition of line-of-sight transmission because the number of obstacles between the aerial user equipment and the base station increases, and the aerial user equipment may face a same transmission environment as a terrestrial user equipment. Therefore, to ensure good communication of the aerial user equipment, more base stations may be selected for the aerial user equipment in this height range. For example, all or a first proportion of the multiple candidate base stations may be selected as the candidate serving base stations of the aerial user equipment, and the first proportion may be, for example, a relatively high proportion such as 90%. Here, the predetermined height may be flexibly determined according to specific conditions of the wireless communication system, for example, the predetermined height may be 50 meters.

In addition, when the height of the aerial user equipment is greater than the predetermined height, the number of the part of the candidate base stations decreases as the height of the aerial user equipment increases. Specifically, when the height of the aerial user equipment is greater than the predetermined height, the number of obstacles between the aerial user equipment and the base station decreases, therefore only a small number of base stations are required to ensure the good communication of the aerial user equipment. Therefore, a smaller number of base stations may be selected by the selecting unit 1001 from all base stations as the candidate serving base stations for the aerial user equipment, as compared with the case where the height of the aerial user equipment is less than the predetermined height. In addition, as the height of the aerial user equipment increases, the communication quality deteriorates because a communication distance between the aerial user equipment and the base station increases, and more base stations may be selected to ensure the good communication of the aerial user equipment, as compared with the flight users at the predetermined height. For example, one or more height ranges may be set from the predetermined height, and for each height range, a corresponding selection proportion for candidate serving base stations is set, so that the corresponding proportion of the candidate serving base stations are selected when the height of the aerial user equipment is within a certain height range.

In a second implementation, the number of the part of the candidate base stations may be the same for the aerial user equipment at different heights.

For example, for the aerial user equipment at different heights, a predetermined proportion of base stations may be selected from multiple candidate base stations as the candidate serving base stations of the aerial user equipment, regardless of the height factor. The predetermined proportion may be flexibly determined according to actual situations of the wireless communication system.

After determining the number of the candidate serving base stations to be selected, next, the candidate serving base stations may be specifically determined from the multiple candidate base stations in various manners.

In a first implementation, the part of the candidate base station may be uniformly or substantially uniformly selected from the multiple candidate base stations as the candidate serving base stations of the aerial user equipment.

As one example, after determining the number of the candidate serving base stations, the base station 10 may select the part of the candidate base stations of this number uniformly or substantially uniformly according to specific geographic locations of the multiple candidate base stations. That is, the serving base station 10 may select the number of candidate serving base stations such that a distribution of the geographic locations of the selected candidate serving base stations is uniform or substantially uniform. It should be noted that the above method of uniform selection is not limited thereto, and any method consistent with the uniform selection is applicable to the present disclosure.

In a second implementation, the serving base station 10 may select the part of the candidate base stations from the multiple candidate base stations according to workloads of respective candidate base stations, as the candidate serving base stations of the aerial user equipment. As one example, the part of the candidate base stations with loads lower than a threshold may be selected from the multiple candidate base stations as the candidate serving base stations of the aerial user equipment. The threshold may be predetermined and may be flexibly determined by the serving base station 10 according to actual situations. For example, the threshold may be a threshold specified in a 3GPP standard. Alternatively, one or more candidate base stations with the lowest load may be selected from the multiple candidate base stations as the candidate serving base stations of the aerial user equipment.

As described above, the multiple candidate base stations may be a part or all of base stations existing in the area where the aerial user equipment is located in the wireless communication system. In this case, a list of all the base stations may be configured by operators and provided to the serving base station 10, such that the serving base station 10 can make the selection.

Alternatively, the multiple candidate base stations may be base stations included in one of multiple NRTs maintained by the serving base station 10.

Specifically, in an LTE system, a base station (for example, the serving base station 10) may detect a neighbor cell by an ANR function, and maintain multiple NRTs according to types of user equipments. The specific content is as described above, and will not be described here.

In a first implementation, the serving base station 10 may maintain multiple neighbor relationship tables, and the multiple neighbor relationship tables correspond to different heights of user equipments respectively. In this case, the multiple candidate base stations are selected from one neighbor relationship table corresponding to the height of the aerial user equipment in the multiple neighbor relationship tables.

In this implementation, the aerial user equipment at a lower height may not have the communication condition of line-of-sight transmission because a number of obstacles between the aerial user equipment at the lower height and the base station increases, and the aerial user equipment at the lower height may face a same transmission environment as a terrestrial user equipment. Therefore, when maintaining the NRTs, the base station may not distinguish between the aerial user equipment and the terrestrial user equipment, but only maintain (establish and/or update) different NRTs according to the height of the user equipment.

As one example, in the case of maintaining the multiple NRTs, the serving base station 10 may divide the found neighboring base stations into one or more groups according to heights, each group corresponding to one height or height range, and a group of neighboring base stations corresponding to a height is included in a NRT corresponding to the height.

In a second implementation, one NRT may be maintained, that is, the found neighboring base stations are included in the one NRT. In addition, these neighboring base stations are divided into one or more groups, each group corresponding to one height or height range. In the NRT, a new attribute may be added to a NR entry corresponding to each neighbor cell. For example, a “Height” attribute is added to the NR entry to indicate a height range corresponding to the base station.

In a third implementation, the serving base station 10 may maintain multiple neighbor relationship tables, and the multiple neighbor relationship tables correspond to different types of user equipments respectively. In this case, the multiple candidate serving base stations are selected from one neighbor relationship table corresponding to a type of the aerial user equipment in the multiple neighbor relationship tables.

As one example, in the case of maintaining the multiple NRTs, the serving base station 10 may divide the found neighboring base stations into multiple groups according to supported types of user equipments, each group corresponding to one type of user equipment, and the group of neighboring base stations corresponding to the type is included in a NRT corresponding to the type. Specifically, as described above, terrestrial user equipment and aerial user equipment may exist in a mobile communication system. Thus, the supported user equipment types may include terrestrial user equipment and aerial user equipment. In this case, for example, a dedicated NRT is maintained for the terrestrial user equipment and another dedicated NRT is maintained for the aerial user equipment.

In a fourth implementation, one NRT may be maintained, that is, the found neighboring base stations are included in the one NRT. In addition, these neighboring base stations are divided into one or more groups, each group corresponding to one type of user equipment. In the NRT, a new attribute may be added to a NR entry corresponding to each neighbor cell. For example, a type of the user equipment corresponding to the “Aerial-serving” attribute may be added into the NR entry, and for example, when selected (“√”), it indicates that the NR may serve the aerial user equipment.

In a fifth implementation, the serving base station 10 may maintain multiple neighbor relationship tables, and the multiple neighbor relationship tables correspond to different heights and types of user equipments respectively. In this case, the multiple candidate base stations are selected from one neighbor relationship table corresponding to the height and the type of the aerial user equipment in the multiple neighbor relationship tables.

As one example, in the case where the multiple NRTs are maintained (established and/or updated) by the ANR function, the serving base station 10 may divide the found neighboring base stations into multiple groups according to the heights or height ranges and the types, each group corresponding to a combination of one type and one height or height range, and a group of neighboring base stations corresponding to a height or height range and a type of user equipment is included in a NRT corresponding to the height or height range and the type.

In a sixth implementation, a shared NRT may be maintained, and in the NRT, a new attribute may be added to a NR entry corresponding to a neighbor cell reported by the user equipment. For example, a “Height” attribute and an “Aerial-serving” attribute are added to the NR entry. The “Height” indicates the height or height range of the user equipment supported by the neighbor cell, the “Aerial-serving” indicates whether the neighbor cell corresponding to the entry supports the aerial user equipment, and, for example, when selected (“√”), it indicates that the NR may serve the aerial user equipment. Then each row of the NR entry corresponds to whether one neighbor cell supports the aerial user equipment and the height range of the supported aerial user equipment.

The transmitting unit 1002 transmits a measurement instruction for the candidate serving base stations to the aerial user equipment.

The measurement instruction may be RRM measurement configuration and/or mobility configuration that instructs the aerial user equipment to measure channel qualities of the candidate serving base stations. It should be appreciated that in addition to the RRM measurement configuration and/or mobility configuration described above, the measurement instruction may be other forms of instruction that instructs the aerial user equipment to perform channel quality measurements on the candidate serving base stations. After measuring the channel qualities of the candidate serving base stations, the aerial user equipment feeds back the measurement results to the base station.

The selecting unit 1003 selects a next serving base station of the aerial user equipment from the candidate serving base stations according to the measurement results.

The selecting unit 1003 receives the measurement results (that is, the channel qualities of the respective candidate serving base stations) transmitted from the aerial user equipment. The base station then selects one base station from the candidate serving base stations according to the received measurement results of the respective candidate serving base stations, as the next serving base station of the aerial user equipment. For example, the serving base station may select one base station with the best channel quality from the respective candidate serving base stations as the serving base station of the aerial user equipment.

After selecting the next serving base station, the base station may transmit a handover request to this serving base station so that the aerial user equipment is handed over to this base station.

Through the above method, only a part of the base stations in the wireless communication system may be used as the candidate serving base stations of the aerial user equipment, thereby avoiding the problem that the communication quality during movement is degraded due to excessive candidate serving base stations.

It should be noted that the serving base station 10 may perform the above method at an appropriate timing. For example, in the case of maintaining NRTs respectively corresponding to different heights, it is assumed that the serving base station 10 is a serving base station selected from an NRT corresponding to a first height. When the height of the aerial user equipment changes to a second height, the serving base station determines whether it is in an NRT corresponding to the second height. If the serving base station is in the NRT corresponding to the second height, the serving base station 10 continues to serve the aerial user equipment. Alternatively, if the serving base station is in the NRT corresponding to the second height, the serving base station 10 may reconfigure the RRM measurement configuration for the aerial user equipment and transmit it to the aerial user equipment, so as to select a new serving base station according to the measurement results of the user equipment. On the other hand, if the serving base station is not in the NRT corresponding to the second height, the serving base station performs the method described above with reference to FIG. 2, reconfiguring the RRM measurement configuration for the aerial user equipment, selecting the next serving base station of the aerial user equipment, and causing the aerial user equipment to hand over to the next serving base station.

In addition, when the serving base station serves the aerial user equipment, interference of remaining base stations (one or more base stations other than the serving base station and the candidate serving base stations) to the aerial user equipment may be reduced by inter-cell interference coordination (ICIC). As one implementation, in the case that the serving base station serves the aerial user equipment, one or more base stations other than the serving base station and the candidate serving base stations may be muted, so that the one or more base stations other than the serving base station and the candidate serving base stations do not send signals when the serving base station is serving the aerial user equipment, so as to reduce the interference of the one or more base stations other than the serving base station and the candidate serving base stations to the aerial user equipment, thereby achieving better communication performance between the aerial user equipment and the wireless communication network.

Specifically, when the serving base station serves the aerial user equipment, a notification may be transmitted to the one or more base stations other than the serving base station and the candidate serving base stations by X2 signaling, so that the one or more base stations other than the serving base station and the candidate serving base stations are muted. The notification may include an indication to perform muting and resource information for performing muting, for example, a subframe, a frequency resource block, or the like. For example, the notification may be transmitted by reusing signaling in an existing coordinated multipoint (CoMP). The notification information may be transmitted by the serving base station of the aerial user equipment or may be transmitted by a central controller controlling all base stations. After receiving the notification information for muting, the base station that needs to be muted is muted according to the notification information. Next, when the serving base station stops serving the aerial user equipment, the muting of the one or more base stations other than the serving base station and the candidate serving base stations may be released by notification information. As described above, the notification information may be transmitted by the serving base station of the aerial user equipment or may be transmitted by the central controller that controls all base stations. The one or more base stations to be muted may be selected from the remaining base stations in different muting patterns.

In one implementation, one or more base stations other than the serving base station and the candidate serving base stations are muted in the same or different muting patterns for the aerial user equipment at different heights. That is, when the aerial user equipment is at different heights, one or more same base stations other than the serving base station and the candidate serving base stations are muted, or one or more different base stations other than the serving base station and the candidate serving base stations are muted. In another implementation, one or more base stations other than the serving base station and the candidate serving base stations are muted in the same or different muting patterns according to the number of base stations serving different aerial user equipments. For example, when there a first number of base stations in the wireless system serving the aerial user equipment, a first group (one or more) of base stations other than the serving base station and the candidate serving base stations are muted, and when there are a second number of base stations in the wireless system serving the aerial user equipment, a second group (one or more) of base stations other than the serving base station and the candidate serving base stations are muted, where at least one different base station may exist between the first group of base stations and the second group of base stations.

Next, an aerial user equipment according to one embodiment of the present disclosure will be described with reference to FIG. 12. FIG. 12 shows a schematic diagram of a structure of an aerial user equipment according to one embodiment of the present disclosure. Since functions of the aerial user equipment of the present embodiment are the same as those of the method described above with reference to FIG. 10, detailed descriptions of the same contents are omitted herein for the sake of simplicity.

As shown in FIG. 12, the aerial user equipment includes a receiving unit 2001, a measuring unit 2002, and a transmitting unit 2003. It should be noted that although the aerial user equipment is shown in FIG. 12 to include only three units, this is merely illustrative, and the aerial user equipment may also include one or more other units, which are not related to the inventive concept and thus are omitted here.

The receiving unit 2001 receives a measurement instruction for candidate serving base stations transmitted by a serving base station, and the candidate serving base stations are a part of the candidate base stations selected from multiple candidate base stations. The measurement instruction for the candidate serving base stations may be received in a manner known in the art, and a method of selecting the candidate serving base stations from the multiple candidate base stations is the same as the above method, details omitted herein.

The measuring unit 2002 may perform measurements on the candidate serving base stations according to the measurement instruction.

The measurement instruction may be RRM measurement configuration and/or mobility configuration that instructs the measuring unit 2002 to measure channel qualities of the candidate serving base stations. It should be appreciated that in addition to the RRM measurement configuration and/or mobility configuration described above, the measurement instruction may be other forms of instruction that instructs the measuring unit 2002 to perform channel quality measurements on the candidate serving base stations.

The transmitting unit 2003 transmits the measurement results to the serving base station.

After measuring the channel qualities of the candidate serving base stations, the transmitting unit 2003 feeds back the measurement results to the base station. The base station selects a next serving base station of the aerial user equipment from the candidate serving base stations according to the measurement results, and then the aerial user equipment is handed over to the next serving base station.

<Hardware Structure>

It should be noted that block diagrams used for the illustration of the above embodiments represent blocks in unit of function. These functional blocks (structural units) are realized by any combination of hardware and/or software. In addition, the means for implementing respective function blocks is not particularly limited. That is, the respective functional blocks may be realized by one apparatus that is physically and/or logically aggregated, or may be realized using two or more physically and/or logically separate apparatus by directly and/or indirectly (for example, wiredly and/or wirelessly) connecting the two or more physically and/or logically separate apparatus.

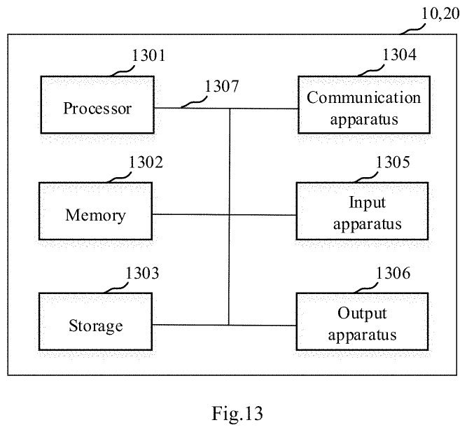

For example, the base station (such as a wireless base station), user equipment or the like in one embodiment of the present invention may function as a computer that executes the processes of the wireless communication method of the present disclosure. FIG. 13 is a diagram illustrating an example of a hardware configuration of a wireless base station and a user equipment to which an embodiment of the present invention is related. The wireless base station 10 and the user equipment 20 described above may be physically designed as a computer apparatus including a processor 1301, a memory 1302, a storage 1303, a communication apparatus 1304, an input apparatus 1305, an output apparatus 1306, a bus 1307 and the like.

Additionally, in the following description, the word “apparatus” may be replaced by “circuit”, “device”, “unit”, or the like. The hardware structure of the wireless base station 10 and the user equipment 20 may be designed to include one or more of respective apparatus shown in the drawings, or may be designed not to include a part of the apparatus.

For example, although only one processor 1301 is shown, a plurality of processors may be provided. Furthermore, processes may be implemented by one processor, or processes may be implemented either simultaneously or in sequence, or in different manners, by one or more processors. Additionally, the processor 1301 may be implemented by one or more chips.

Each function of the wireless base station 10 and the user equipment 20 is implemented by, for example, reading predetermined software (program) onto hardware such as the processor 1301 and the memory 1302, so as to make the processor 1301 perform calculations, control communication carried out by the communication apparatus 1304, and control reading and/or writing of data in the memory 1302 and the storage 1303.

The processor 1301 may control the whole computer by, for example, running an operating system. The processor 1301 may be configured with a central processing unit (CPU), which includes interfaces with peripheral apparatus, control apparatus, computing apparatus, a register and so on.

Furthermore, the processor 1301 reads programs (program codes), software modules, data or the like, from the storage 1303 and/or the communication apparatus 1304 into the memory 1302, and executes various processes according to them. As for the programs, programs to allow a computer to execute at least part of operations described in the above embodiments may be used. For example, the measuring unit 2002 of the user equipment 20 may be implemented by a control program stored in the memory 1302 and operated by the processor 1301, and other function blocks may be implemented similarly.

The memory 1302 is a computer-readable recording medium, and may be constituted by, for example, at least one of a ROM (Read Only Memory), an EPROM (Erasable Programmable ROM), an EEPROM (Electrically EPROM), a RAM (Random Access Memory) and other appropriate storage media. The memory 1302 may be referred to as a “register”, a “cache”, a “main memory” (primary memory apparatus) and so on. The memory 1302 can store executable programs (program codes), software modules and so on for implementing the wireless communication methods according to embodiments of the present invention.

The storage 1303 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk, a removable disk, a hard disk drive, a smart card, a flash memory device (for example, card, stick, key drive, etc.), a magnetic stripe, a database, a server, and other appropriate storage media. The storage 1303 may be referred to as “secondary storage apparatus.”

The communication apparatus 1304 is hardware (transmitting/receiving device) for performing inter-computer communication by using wired and/or wireless networks, and may be referred to as, for example, a “network device”, a “network controller”, a “network card”, a “communication module”, and so on. The communication apparatus 1304 may be configured to include a high frequency switch, a duplexer, a filter, a frequency synthesizer and so on, in order to realize, for example, frequency division duplex (FDD) and/or time division duplex (TDD).

The input apparatus 1305 is an input device for receiving input from outside (for example, a keyboard, a mouse, a microphone, a switch, a button, a sensor or the like). The output apparatus 1306 is an output device for sending output to outside (for example, a display, a speaker, an LED (Light Emitting Diode) lamp or the like). Additionally, the input apparatus 1305 and the output apparatus 1306 may be provided in an integrated structure (for example, a touch panel).

Furthermore, the respective apparatus, including the processor 1301, the memory 1302 and so on, are connected by the bus 1307 for communicating information. The bus 1307 may be formed with a single bus, or may be formed with different buses between apparatus.

Also, the wireless base station 10 and user equipment 20 may include hardware such as a microprocessor, a digital signal processor (DSP), an ASIC (Application-Specific Integrated Circuit), a PLD (Programmable Logic Device), an FPGA (Field Programmable Gate Array) and so on, and a part or all of the functional blocks may be implemented by the hardware. For example, the processor 1301 may be installed with at least one of these pieces of hardware.

(Variations)

Additionally, the terms illustrated in the present specification and/or the terms required for understanding of the present specification may be substituted with terms having the same or similar meanings. For example, a channel and/or a symbol may be a signal (signaling). In addition, the signal may be a message. A reference signal may be abbreviated as a “RS (Reference Signal)”, and may be referred to as a “pilot”, a “pilot signal” and so on, depending on which standard applies. In addition, a component carrier (CC) may be referred to as a cell, a carrier frequency, a frequency carrier, or the like.

Also, the information, parameters and so on described in this specification may be represented in absolute values or in values relative to predetermined values, or may be represented in other corresponding information. For example, radio resources may be indicated by predetermined indices. In addition, equations using these parameters and so on may be different from those explicitly disclosed in this specification.

The names used for parameters and so on in this specification are not limitative in any respect. For example, various channels (PUCCH (Physical Uplink Control Channel), PDCCH (Physical Downlink Control Channel) and so on) and information elements can be identified by any suitable names, so various names assigned to these various channels and information elements are not limitative in any respect.

The information, signals and so on described in this specification may be represented by using any one of various different technologies. For example, data, instructions, commands, information, signals, bits, symbols and chips, which may be referenced throughout the herein-contained description, may be represented by voltages, currents, electromagnetic waves, magnetic fields or particles, optical fields or photons, or any combination thereof.

Also, information, signals and so on can be output from a higher layer to a lower layer and/or from a lower layer to a higher layer. Information, signals and so on may be input or output via a plurality of network nodes.

The information, signals and so on that are input or output may be stored in a specific location (for example, in a memory), or may be managed in a management table. The information, signals and so on that are input or output may be overwritten, updated or appended. The information, signals and so on that are output may be deleted. The information, signals and so on that are input may be transmitted to other apparatus.

Reporting of information is by no means limited to the aspects/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (Master Information Block (MIB), System Information Block (SIB) and so on), MAC (Medium Access Control) signaling and so on), and other signals and/or combinations thereof.

Additionally, physical layer signaling may also be referred to as L1/L2 (Layer 1/Layer 2) control information (L1/L2 control signal), L1 control information (L1 control signal) and so on. Also, RRC signaling may be referred to as “RRC message”, and can be, for example, a RRC connection setup message, a RRC connection reconfiguration message, and so on. Also, MAC signaling may be reported using, for example, a MAC control element (MAC CE (Control Element)).

Also, reporting of predetermined information (for example, reporting of “being X”) does not necessarily have to be carried out explicitly, and can be carried out implicitly (by, for example, not reporting this predetermined information, or by reporting different information).

A decision may be made through values represented by one bit (0 or 1), may be made by a true or false value (Boolean value) represented by True or False, or may be made by comparing numerical values (for example, comparison against a predetermined value).

Software, whether referred to as “software”, “firmware”, “middleware”, “microcode” or “hardware description language”, or called by other names, should be interpreted broadly to mean instructions, instruction sets, codes, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote source by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are included in the definition of communication media.

The terms “system” and “network” as used herein are used interchangeably.

In the present specification, the terms “base station (BS)”, “wireless base station”, “eNB”, “gNB”, “cell”, “sector”, “cell group”, “carrier” and “component carrier” may be used interchangeably. A base station may be referred to as a “fixed station”, “NodeB”, “eNodeB (eNB)”, “access point”, “transmission point”, “receiving point”, “femto cell”, “small cell” and so on.

A base station can accommodate one or more (for example, three) cells (also referred to as “sectors”). When a base station accommodates a plurality of cells, an entire coverage area of the base station can be partitioned into a plurality of smaller areas, and each smaller area can provide communication services through a base station subsystem (for example, indoor small base station (RRH (Remote Radio Head))). The term “cell” or “sector” refers to a part or all of the coverage area of a base station and/or a base station subsystem that provides communication services within this coverage.

In the present specification, the terms “mobile station (MS)”, “user terminal”, “user equipment (UE)” and “terminal” may be used interchangeably.

A mobile station is sometimes referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

Furthermore, the wireless base station in this specification may be replaced with the user equipment. For example, respective aspects/embodiments of the present invention may be applied to a configuration in which communication between a wireless base station and a user equipment is replaced with communication among a plurality of user devices (D2D (Device-to-Device)). In this case, the functions of the wireless base station 10 described above may be treated as the functions of the user equipment 20. In addition, terms such as “uplink” and “downlink” may be replaced with “side.” For example, an uplink channel may be replaced with a side channel.

Likewise, the user equipments in this specification may be replaced with a wireless base station. In this case, the functions of the user equipment 20 may be treated as the functions of the wireless base station 10.

In the present specification, it is assumed that certain actions performed by the base station may, in some cases, be performed by its upper node. In a network comprising one or more network nodes with base stations, it is clear that various operations that are performed to communicate with terminals can be performed by base stations, one or more network nodes other than base stations (for example, MMEs (Mobility Management Entities), S-GW (Serving-Gateways), and so on may be possible, but these are not limitative), or a combination thereof.

The respective aspects/embodiments illustrated in this specification may be used individually or in combination, which may also be switched and used during execution. The order of process steps, sequences, flowcharts and so on of the respective aspects/embodiments described in the present specification may be re-ordered as long as inconsistencies do not arise. For example, although various methods have been illustrated in this specification with various components of steps in exemplary orders, the specific orders that are illustrated herein are by no means limitative.

The aspects/embodiments illustrated in this specification may be applied to systems that use LTE (Long Term Evolution), LTE-A (LTE-Advanced), LTE-B (LTE-Beyond), SUPER 3G (super 3rd generation mobile communication system), IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000 (code division multiple access 2000), UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark) and other appropriate wireless communication methods, and/or next-generation systems that are enhanced based on them.

The phrase “based on/according to” as used in this specification does not mean “only based on/only according to”, unless otherwise specified in other paragraphs. In other words, the phrase “based on/according to” means both “only based on/only according to” and “at least based on/at least according to.”

Any reference to elements with designations such as “first”, “second” and so on as used herein does not generally limit the number/quantity or order of these elements. These designations are used only for convenience, as a method of distinguishing between two or more elements. In this way, reference to the first and second elements does not imply that only two elements may be employed, or that the first element must precede the second element in some way.

The terms “judge” and “determine” as used herein may encompass a wide variety of actions. For example, for “judge” and “determine”, calculating, computing, processing, deriving, investigating, looking up (for example, searching a table, a database or some other data structure), ascertaining and so on may be regarded as “judge” and “determine”. Furthermore, for “judge” and “determine”, receiving (for example, receiving information), transmitting (for example, transmitting information), inputting, outputting, accessing (for example, accessing data in a memory) and so on may be regarded as “judge” and “determine”. In addition, for “judge” and “determine”, resolving, selecting, choosing, establishing, comparing and so on may be regarded as “judge” and “determine”. In other words, for “judge” and “determine”, several actions may be regarded as “judge” and “determine”.

As used herein, the terms “connected” and “coupled”, or any variation of these terms, mean any direct or indirect connections or coupling between two or more elements, and may include the presence of one or more intermediate elements between two elements that are “connected” or “coupled” to each other. The coupling or connection between the elements may be physical, logical or a combination thereof. For example, “connection” may be replaced with “access.” As used herein, two elements may be considered “connected” or “coupled” to each other by using one or more electrical wires, cables and/or printed electrical connections, and, as a number of non-limiting and non-inclusive examples, by using electromagnetic energy, such as electromagnetic energy having wavelengths in radio frequency fields, microwave regions and light (both visible and invisible) regions.

When terms such as “include”, “comprise” and variations thereof are used in this specification or in claims, these terms are intended to be inclusive, in a manner similar to the way the term “provide/have” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented in various modifications and alternations, without departing from the spirit and scope of the present invention defined by the recitations of claims. Consequently, the description herein is provided only for the purpose of explaining examples, and should by no means be construed to limit the present invention in any way.

1.-10. (canceled)

11. A base station, comprising:
a selecting unit configured to select a part of candidate base stations from multiple candidate base stations as candidate serving base stations of an aerial user equipment;
a transmitting unit configured to transmit a measurement instruction for the candidate serving base stations to the aerial user equipment; and
a selecting unit configured to select a next serving base station of the aerial user equipment from the candidate serving base stations according to measurement results.

12. The base station according to claim 11, wherein
the selecting unit selects the part of candidate base stations from the multiple candidate base stations according to a height of the aerial user equipment, as the candidate serving base stations of the aerial user equipment.

13. The base station according to claim 12, wherein
the number of the part of candidate base stations is same or different for the aerial user equipment at different heights.

14. The base station according to claim 11, wherein
the selecting unit uniformly selects the part of candidate base station from the multiple candidate base stations as the candidate serving base stations of the aerial user equipment.

15. The base station according to claim 11, wherein
the selecting unit selects the part of candidate base stations from the multiple candidate base stations according to workloads, as the candidate serving base stations of the aerial user equipment.

16. The base station according to claim 11, wherein
the current serving base station of the aerial user equipment maintains multiple neighbor relationship tables, the multiple neighbor relationship tables correspond to different heights of user equipment respectively, and the multiple candidate base stations are selected from one neighbor relationship table corresponding to a height of the aerial user equipment in the multiple neighbor relationship tables.

17. The base station according to claim 11, wherein
the current serving base station of the aerial user equipment maintains multiple neighbor relationship tables, the multiple neighbor relationship tables correspond to different types of user equipment respectively, and the multiple candidate base stations are selected from one neighbor relationship table corresponding to a type of the aerial user equipment in the multiple neighbor relationship tables.

18. The base station according to claim 11, wherein
the current serving base station of the aerial user equipment maintains multiple neighbor relationship tables, the multiple neighbor relationship tables correspond to different heights and types of user equipments respectively, and the multiple candidate base stations are selected from one neighbor relationship table corresponding to a height and a type of the aerial user equipment in the multiple neighbor relationship tables.

19. The base station according to claim 11, wherein
when the serving base station serves the aerial user equipment, one or more base stations other than the serving base station and the candidate serving base stations are muted.

20. The base station according to claim 19, wherein
the one or more base stations other than the serving base station and the candidate serving base stations are muted in different muting patterns, according to a height of the aerial user equipment or a number of base stations serving different aerial user equipments.

21. A method of wireless communication, applied to a current serving base station of an aerial user equipment, comprising:
selecting a part of candidate base stations from multiple candidate base stations as candidate serving base stations of the aerial user equipment;
transmitting, to the aerial user equipment, a measurement instruction for the candidate serving base stations; and
selecting a next serving base station of the aerial user equipment from the candidate serving base stations according to measurement results.

22. The method according to claim 21, wherein the selecting a part of candidate base stations from multiple candidate base stations as candidate serving base stations of the aerial user equipment includes:
selecting the part of candidate base stations from the multiple candidate base stations according to a height of the aerial user equipment, as the candidate serving base stations of the aerial user equipment.

23. The method according to claim 22, wherein
the number of the part of candidate base stations is same or different for the flight user equipment at different heights.

24. The method according to claim 21, wherein the selecting a part of candidate base stations from multiple candidate base stations as candidate serving base stations of the aerial user equipment includes:
selecting the part of candidate base station uniformly from the multiple candidate base stations as the candidate serving base stations of the aerial user equipment.

25. The method according to claim 21, wherein the selecting a part of candidate base stations from multiple candidate base stations as candidate serving base stations of the aerial user equipment includes:
selecting the part of candidate base stations from the multiple candidate base stations according to workloads, as the candidate serving base stations of the aerial user equipment.

26. The method according to claim 21, wherein
the current serving base station maintains multiple neighbor relationship tables, the multiple neighbor relationship tables correspond to different heights of user equipment respectively, and the multiple candidate base stations are selected from one neighbor relationship table corresponding to the height of the aerial user equipment in the multiple neighbor relationship tables.

27. The method according to claim 21, wherein
the current serving base station maintains multiple neighbor relationship tables, the multiple neighbor relationship tables correspond to different types of user equipment respectively, and the multiple candidate base stations are selected from one neighbor relationship table corresponding to a type of the aerial user equipment in the multiple neighbor relationship tables.

28. The method according to claim 21, wherein
the current serving base station maintains multiple neighbor relationship tables, the multiple neighbor relationship tables correspond to different heights and types of user equipment respectively, and the multiple candidate base stations are selected from one neighbor relationship table corresponding to a height and a type of the aerial user equipment in the multiple neighbor relationship tables.

29. The method according to claim 21, wherein
when the serving base station serves the aerial user equipment, one or more base stations other than the serving base station and the candidate serving base stations are muted.

30. The method according to claim 29, wherein
the one or more base stations other than the serving base station and the candidate serving base stations are muted in different muting patterns, according to a height of the aerial user equipment or a number of base stations serving different aerial user equipments.
